(19) United States
(12) Patent Application Publication
(10) Pub. No.: US 2002/0012566 A1
(43) Pub. Date: Jan. 31, 2002

(54) Releasable lockable joint apparatus

(75) Inventors: Geof F. Auchinleck, Vancouver (CA); Brent W. King, Calgary (CA); Ken W. Moore, Calgary (CA)

Correspondence Address: BLAKE, CASSELS & GRAYDON LLP, World Exchange Plaza, 20th Floor, 45 O'Connor Street, Ottawa, ON, K1P 1A4, CA

(73) Assignee: Tenet Medical Engineering Inc.

(21) Appl. No.: 09/741,874

(22) Filed: Dec. 22, 2000

(30) Foreign Application Priority Data
Jul. 28, 2000 (CA) 2,314,710

(51) Int. Cl. F16D 1/12; F16C 11/06

(52) U.S. Cl. 403/90

(57) ABSTRACT

Discloses a paired ball and socket joint assembly where the balls of the ball pair are interconnected by a rigid connecting member. Each socket housing is rotatably and angularly displaceable about its associated ball. The paired ball and socket joint apparatus permits greater range of rotational and angular movement between the socket housings than can be provided by a single ball and socket apparatus.

### FIELD OF THE INVENTION

This invention relates to lockable joint apparatus.

### BACKGROUND TO THE INVENTION

Frequently, it is desired to orient two items with respect to each other, such as a base to a table top or the limbs of a positioning arm, and lock the resulting arrangement.

### SUMMARY OF THE INVENTION

There is a need to have a lockable joint that has capability for a wide range of positioning with minimal positioning limitations.

In one of its aspects, the invention provides a re-postitionable, lockable joint apparatus including a pair of ball means disposed at either end of a connecting member. Each ball means includes a housing to receive said ball means and the housing forms a seat dimensioned to surround a girth of the ball means. Lock means are slidingly disposed within the housing. The lock means are operable between a locked position and a released position. In the locked position, the ball means is maintained in fixed relationship to the housing. In the released position, the housing may be angularly rotated and angularly displaced with respect to the ball means. The joint has activation means responsive to fluid pressure to move said lock means between the locked position and the released position.

In another of its aspects, the invention provides a re-positionable, lockable joint apparatus including a pair of ball means disposed at either end of a connecting member and where each ball means has a housing to receive the ball therein. Each ball means further includes a collar disposed on one side of the housing forming a seat to surround a girth of the ball. A piston is slidingly disposed within the housing one end thereof including a seat adapted for mating engagement with the ball and the other end of the piston forms a chamber within the housing However, when the coupling is not in the locked position, first ball assembly 54 is free to rotate in three-dimensional space within the housing 52 and collar 66 thereby allowing the rigid interconnecting element 58 to be rotated and/or angularly displaced relative to housing 52. The displacement of the rigid interconnecting member or element 58 can include rotational displacement which includes rotation of the pressure supply line 60. Pressure supply line 60 is sealingly coupled within housing 52 by means of first rotatable sealed coupling 62 and seals 55. Also, when the coupling is not in a locked position, rotatable seal 62 allows pressure supply line 60 to rotate within or with respect to piston 53 while maintaining a sealed relationship therewith.

Similarly for the other ball assembly 68a, collar 66a is preferably removable from housing 52a to effect assembly and maintenance of the ball and socket joint assembly as required. For example, collar 66a may be threadingly coupled to housing 52a. Collar 66a surrounds a girth of the ball of second ball assembly 56 and forms a seating surface 68a that mates with the exterior surface of the ball of second ball assembly 56. When collar 66a is secured to housing 52a, the second ball assembly 56 cannot be removed from the housing 52a and collar 66a assembly as the diameter of the opening of collar 66a through which interconnecting member 58 extends is smaller than the diameter of the ball of second ball assembly 56. However, when the coupling is not in the locked position, second ball assembly 56 is free to rotate in three-dimensional space within the housing 52a and collar 66a thereby allowing the rigid interconnecting element 58 to be rotated and/or angularly displaced relative to housing 52a. The displacement of the rigid interconnecting member or element 58 can include rotational displacement which includes rotation of the pressure supply line 60. Pressure supply line 60 is sealingly coupled within housing 52a by means of first rotatable sealed coupling 64 and seals 55a. Also, when the coupling is not in a locked position, rotatable seal 64 allows pressure supply line 60 to rotate within or with respect to piston 53a while maintaining a sealed relationship therewith.

To lock first ball assembly 54 with respect to housing 52, a pressurized fluid such as hydraulic fluid is supplied to piston chamber 48 via supply passage 50. The pressurized fluid applies a force to piston 53 to urge upwardly on piston 53 in the direction of arrows 70. Piston 53 travels upwardly until seat 72 engages first ball assembly 54 thereby compressing the ball assembly 54 between seat 72 and seating surface 68 of collar 66. When this compression seating occurs, first ball assembly 54 is maintained in a locked position to maintain the configuration with respect to housing 52 thereby preventing any relative movement therebetween. In the locked position, the configuration of interconnecting member 58 with respect to housing 52 is maintained as interconnecting member 58 cannot move relative to housing 52.

Simultaneously with the action of the pressurized fluid causing piston 53 to move in the direction of arrows 70, the communicating passageway, established by first rotatable seal 62, pressure supply line 60 and second rotatable seal 64, extending to second piston chamber 48a, causes piston 53a to be urged to move in the direction of arrow 70a to urge seat 72a toward seat 68a thereby compressing second ball assembly 56 therebetween. When second ball assembly 56 is compressed between seats 72a and 68a, it is rigidly held in position relative to housing 52a. In the locked position, the configuration of interconnecting member 58 with respect to housing 52a is maintained as interconnecting member 58 cannot move relative to housing 52a.

Thus the supply of a pressurized fluid from the supply passage 50 causes the joint to become locked in position.

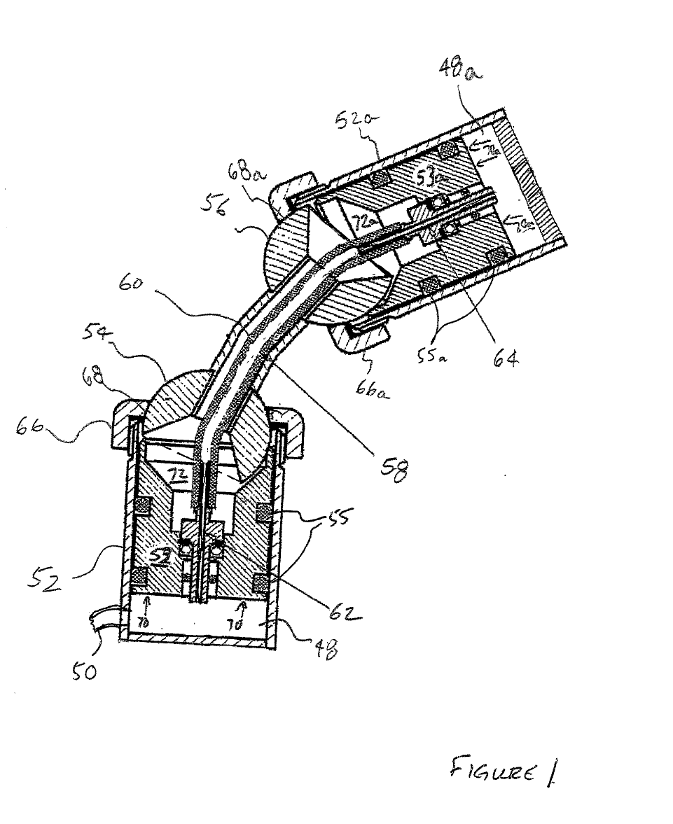

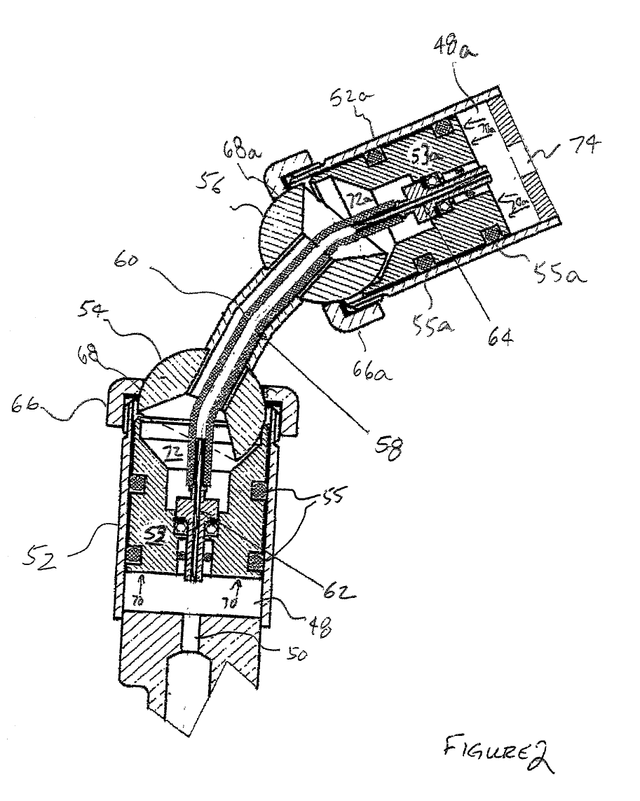

FIG. 2 shows an alternate embodiment of the invention where the second piston chamber 48a is provided with a fluid egress passage to allow a plurality of lockable joints to be commonly activated by the supply of a pressurized fluid. The pressurized fluid is communicated to egress passage 74 to permit the fluid pressure to be transmitted externally to other lockable joints.

Now that the invention has been described with reference to the attached drawings, numerous substitutions, modifications and equivalents will occur to those skilled in the art. The invention is defined by the claims appended hereto.

The exclusive embodiments of the invention in which an exclusive property or privilege is claimed are as follows:

1. A re-postitionable, lockable joint apparatus comprising:
(a) a pair of ball means disposed at either end of a connecting member,
(b) for each ball means,
(i) a housing to receive said ball means, the housing including a seat surrounding a girth of the ball means,
(ii) lock means slidingly disposed within said housing operable between a locked position wherein said ball means is maintained in fixed relationship to said housing and a released position wherein said housing may be angularly rotated and angularly displaced with respect to the ball means, and
(c) activation means to move said lock means between the locked position and the released position.

2. The apparatus of claim 1, wherein said activation means is responsive to fluid pressure.

3. The apparatus of claim 2, wherein the activation means in fluid communication with each other via the connecting member.

4. A re-positionable, lockable joint apparatus comprising:
(a) a pair of ball means disposed at either end of a connecting member,
(b) for each ball means:
i) a housing to receive said ball therein;
ii) a collar disposed on one side of said housing forming a seat to surround a girth of said ball; and
iii) a piston slidingly disposed within said housing one end thereof including a seat adapted for mating engagement with said ball and the other end of said piston forming a chamber within said housing.
wherein the piston is responsive to pressurized fluid in said chamber to lock the ball in fixed relation to the housing.
